(19) United States
(12) Patent Application Publication
(10) Pub. No.: US 2003/0204654 A1
(43) Pub. Date: Oct. 30, 2003

(54) Keyboard lock data transfer

(76) Inventor: Robert H. Nathan, Atlanta, GA (US)

Correspondence Address: PAUL W. MARTIN, LAW DEPARTMENT, WHQ-5E, 1700 S. PATTERSON BLVD., DAYTON, OH, 45479-0001, US

(21) Appl. No.: 10/132,381

(22) Filed: Apr. 26, 2002

(51) Int. Cl. G06F 13/12

(52) U.S. Cl. 710/67

(57) ABSTRACT

A method of transmitting lock position information from a human interface device coupled via universal serial bus is described. The lock position information is transmitted using a keylock usage. Numerous lock positions are possible and exemplary positions include locked, normal, supervisor, and maintenance. A lock unit aspect for generating lock position information is described. The lock unit includes a lock having at least two positions, a lock sensor coupled to the lock and adapted to sense the lock position, and a data connection adapted to interface with a computer and pass a keylock usage.

### FIELD OF THE INVENTION

The present invention is related to a method of and apparatus for keyboard lock data transfer; and more particularly, to a method and apparatus for keyboard lock data transfer using the Universal Serial Bus (USB) protocol.

### BACKGROUND ART

It is known in the art to equip keyboards and other peripherals with locks as a security device to help authorize equipment use by individuals having different privileges. The peripheral devices may be connected to a computer through different physical and logical interconnections. Regardless of the method of connection, the position of a key in the lock must be reported, transmitted, or otherwise made available to the computer to which the lock is connected. The lock may be connected directly to the computer or connected via a keyboard or other peripheral device to the computer.

Locks on peripheral devices may be as simple as having two states: locked and unlocked. Other environments require locks having multiple states: locked, unlocked, normal, supervisor or override, and maintenance. Normal, supervisor, and maintenance modes pertain to the amount of privileges that a particular user has when operating a computer having a lock in one of these states. A lock in one of these states may be viewed similar to the different privileges accorded to users logging on to a computer system using a username and password approach as is known in the art.

It is also known in the art to connect keyboards, keypads, or other peripheral devices, to a computer by using different physical or logical connections. If a universal serial bus (USB) is the connection mechanism, keylock position information is formed into packets with certain common USB characteristics and other characteristics specific to keylock position.

The general protocol for transmitting data over USB is defined in specifications licensed by the USB Implementer's Forum (USBIF) or published by the USB device working group (DWG) on the public Web site, i.e., http://www.usb.org. Existing USB protocol definitions permit many different ways of transmitting data. For example, the USBIF defines four types of data transmission: control, interrupt, bulk, and isochronous. Each type of data transmission includes specific characteristics. A USB device may transmit data using one or more of the data transmission types, also known as endpoint types.

The USB DWG has defined several classes of devices. Each class uses a specified set of the above described endpoint types. Each class further specifies the format of the data to be transmitted. One such defined class is the human interface device (HID) class. The HID class, as defined by the USB DWG and specified in the Device Class Definition for Human Interface Devices (HID), hereinafter the HID Specification, version 1.11 published Jun. 27, 1001 by the USBIF and available from http://www.usb.org, specifies some, but not all, of the characteristics of the transmitted data. More particularly, the HID class specifies a mechanism by which a device designer can provide extensions to the HID specification. These extensions are called usages, and a HID class device sends and receives data using either published, pre-defined usages, privately invented usages, or a combination of public and private usages. Furthermore, a HID class device formats data in a manner causing these usages to have specific, useful meaning to the host computer.

However, the specification found in the USB HID Class Specification does not specify a usage for HIDs equipped with a lock.

### DISCLOSURE/SUMMARY OF THE INVENTION

It is therefore an object of the present invention to provide a method and apparatus for lock position information transfer using a universal serial bus.

Another object of the present invention is to provide a method and apparatus for keyboard lock position information transfer using a universal serial bus.

In accordance with a method aspect, lock position information from a human interface device coupled via universal serial bus is transmitted. The lock position information is transmitted using a keylock usage. Numerous lock positions are possible and exemplary positions include locked, normal, supervisor, and maintenance.

An apparatus aspect includes a lock unit for generating lock position information is described. The lock unit includes a lock having at least two positions, a lock sensor coupled to the lock and adapted to sense the lock position, and a data connection adapted to interface with a computer and pass a keylock usage.

As used herein, the term “serial” refers to the “RS-232 family” of interfaces and the term “USB” refers to the standard(s) developed and published by the USBIF (Universal Serial Bus Implementer's Forum), recently incorporated under that name.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation in the figures of the accompanying drawings, wherein elements having the same reference numeral designations represent like elements throughout and wherein:

FIG. 1 is a high level block diagram of a computer system useable with a preferred embodiment of the present invention; and

FIG. 2 is a functional block diagram of a keyboard used in FIG. 1.

### BEST MODE FOR CARRYING OUT THE INVENTION

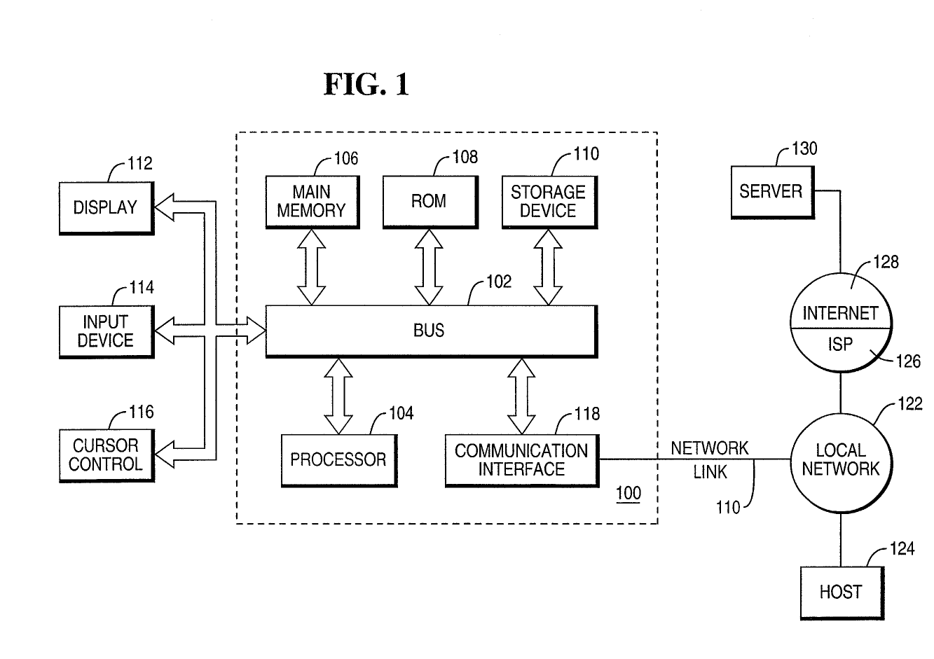

A computer system useable with a preferred embodiment of the present invention is now described with reference to FIG. 1.

Hardware Overview

FIG. 1 is a block diagram illustrating an exemplary computer system 100 in conjunction with which a preferred embodiment of the invention may operate and be implemented. The present invention is usable with currently available personal computers, mini-mainframes and other computers having USB connectivity.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing USB usages, e.g., keylock usage, button usages, data, and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 210, such as a magnetic disk or optical disk, is provided and coupled to the bus 102 for storing USB usages, keylock position, data, and instructions.

Computer system 100 may be coupled via the bus 102 to a display 212, such as a cathode ray tube (CRT) or a flat panel display, for displaying information to a user. An input device or human interface device (HID) 214, e.g., a keyboard or keypad including alphanumeric and function keys, is coupled to computer system 100 for communicating information and command selections to processor 104. HID 214 is a USB-based device and communicates with computer system 100 using the USB protocol as is known to persons of skill in the art and as modified below in accordance with the present invention. Another type of human interface device is cursor control 216, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

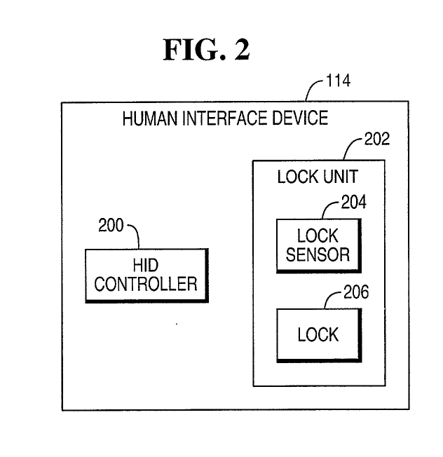

The invention is related to the use of computer system 100, such as the illustrated system of FIG. 2, to transmit tone information in the form of novel USB HID usages, i.e., keylock usage, to HID 114. According to one embodiment of the invention, the keylock usages are transmitted to HID 114 by computer system 100 in response to processor 104 executing sequences of instructions contained in main memory 106. Such instructions may be read into main memory 106 from another computer-readable medium, such as storage device 110.

However, the computer-readable medium is not limited to devices such as storage device 110. For example, the computer-readable medium may include a floppy disk, a flexible disk, hard disk, magnetic tape, or any other magnetic medium, a compact disc-read only memory (CD-ROM), any other optical medium, punch cards, paper tape, any other physical medium with patterns of holes, a random access memory (RAM), a programmable read only memory (PROM), an erasable programmable ROM (EPROM), a Flash-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides two-way data communication as is known. For example, communication interface 118 may be an integrated services digital network (ISDN) card, a digital subscriber line (DSL) card, or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals which carry digital data streams representing various types of information. Of particular note, the communications through interface 118 may permit transmission or receipt of USB keylock usages. For example, two or more computer systems 100 may be networked together in a conventional manner with each using the communication interface 18.

Network link 110 typically provides data communication through one or more networks to other data devices. For example, network link 110 may provide a connection through local network 112 to a host computer 114 or to data equipment operated by an Internet Service Provider (ISP) 116. ISP 116 in turn provides data communication services through the world wide packet data communication network now commonly referred to as the “Internet” 118. Local network 112 and Internet 118 both use electrical, electromagnetic or optical signals which carry digital data streams. The signals through the various networks and the signals on network link 110 and through communication interface 118, which carry the digital data to and from computer system 100, are exemplary forms of carrier waves transporting the information.

Computer system 100 can send messages and receive data, including program code, through the network(s), network link 110 and communication interface 118. In the Internet example, a server 110 might transmit a requested code for an application program through Internet 118, ISP 116, local network 112 and communication interface 118. In accordance with the invention, one such downloaded application provides for receiving keylock usages from USB-based HID 114 for specification of keylock position information.

The received code may be executed by processor 104 as it is received, and/or stored in storage device 110, or other non-volatile storage for later execution. In this manner, computer system 100 may obtain application code in the form of a carrier wave.

USB-based HID or keyboard 114 is now described in detail with reference to FIG. 3. HID 114 is connected to computer system 100 via USB. As depicted in FIG. 3, HID 114 includes a HID controller 200 for receiving commands from and transmitting information to computer system 100 using the USB and a lock unit 202 for generating keylock position information. As described in detail below, HID controller 200 receives keylock usages, i.e., button usage indicating keylock position information, from lock unit 202 and transmits the usages to computer system 100 for use by processor 104 executing sequences of instructions and for storage in main memory 106 or storage device 110. HID controller 200 is a programmable logic device, e.g., a field programmable gate array (FPGA).

Lock unit 202 includes a lock sensor 204 for sensing the position of lock 206 and transmitting keylock usages (described in detail below) to HID controller 200. Lock sensor 204 is a programmable logic device similar to HID controller 200, e.g., a field programmable gate array (FPGA). Lock 206 is known to persons of skill in the art and is coupled to lock sensor 204.

In an alternate embodiment, lock sensor 204 may be combined with and made a part of HID controller 200 without detracting from the present invention. In such an implementation, HID controller 200 directly senses the position of lock 206.

In another alternate embodiment, lock unit 202 is a separate device from HID 114. In such an implementation, lock unit 202 may be directly connected to HID 114 and transmit keylock usages to HID 114 using a USB connection.

In still another alternate embodiment, lock unit 202 is a separate device, as described above, and may be directly connected to computer system 100. Lock unit 202, in such a configuration, transmits keylock usages to computer system 100 using a USB connection.

A detailed description of the keylock usages of a preferred embodiment of the present invention is now provided.

The present invention defines the parameters of keylock position for a USB-based keylock as being transmitted using a custom HID usage called keylock usage. The keylock usage acts as a collection refining the meaning of the USB button usages as pertaining to a keylock associated with a keyboard or other peripheral or as a stand-alone USB device. The keylock usage is a top-level class and is not itself transmitted to HID 114. In accordance with the HID Specification, top-level usages, such as the keyboard usage, are transmitted in report descriptors at computer system 200 startup and/or connection of a HID device to the computer system. Report identifiers, as specified in the HID Specification, are used to correlate usages to reports but are not required for operation of the present invention. One or the other of the button usages is transmitted as a type of keylock usage class.

The keylock usage acts as a collection further refining the meaning of the button usages as pertaining to a keylock position sensed from lock 206 the lock is manipulated. The keylock usage, including the button specifications, is stored at lock sensor 204. When a keylock connected to keyboard 114 is manipulated by a user, lock sensor 204 transmits a signal to inform HID controller 200 of the lock 206 position. Lock sensor 204 determines, based on the stored keylock usage and the protocols of the HID Specification, the position of lock 206.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of transmitting lock position information from a human interface device coupled via universal serial bus, the method comprising:
transmitting lock position information using a keylock usage.

2. The method as claimed in claim 1, wherein the keylock usage is a collection of a button usage.

3. The method as claimed in claim 2, wherein the keylock usage is a collection of a lock, normal, supervisor, and maintenance values.

4. The method as claimed in claim 1, wherein the keylock usage includes at least one of lock, normal, supervisor, and maintenance values.

5. The method as claimed in claim 1, wherein the keylock usage includes each one of lock, normal, supervisor, and maintenance values.

6. The method as claimed in claim 1, further comprising:
storing the transmitted keylock usage at a computer system.

7. The method as claimed in claim 1, further comprising:
storing the transmitted keylock usage at the human interface device.

8. The method as claimed in claim 1, further comprising:
responsive to a lock position change at the human interface device, transmitting the keylock usage.

9. The method as claimed in claim 1, wherein the keylock usage transmission step is performed responsive to a user manipulating the human interface device.

10. A lock unit for generating lock position information, comprising:
a lock having at least two positions;
a lock sensor coupled to the lock and adapted to sense the lock position;
a data connection adapted to interface with a computer and pass a keylock usage.

11. The lock unit as claimed in claim 10, wherein the data connection is a universal serial bus connection.

12. The lock unit as claimed in claim 10, wherein the lock sensor is a programmable logic device.

13. The lock unit as claimed in claim 12, wherein the programmable logic device is a field programmable gate array.

14. The lock unit as claimed in claim 10, wherein the lock sensor stores keylock usages.

15. The lock unit as claimed in claim 10, wherein the keylock usage is a button usage.

16. The lock unit as claimed in claim 10, wherein the lock includes a locked position, a normal position, a supervisor position, and a maintenance position.

17. A computer readable medium, comprising:
at least one keylock usage; and
at least one sequence of machine executable instructions in machine form, wherein execution of the instructions by a lock sensor connected to a lock causes the lock sensor to:
detect a position of the lock;
determine a keylock usage corresponding to the detected lock position; and
transmit the keylock usage to a connected computer.

18. The computer readable medium as claimed in claim 17, wherein the keylock usage includes a button usage.

19. The computer readable medium as claimed in claim 17, wherein the lock position includes a locked position, a normal position, a supervisor position, and a maintenance position.

20. A computer system, comprising:
a processor;
a lock unit coupled to the processor; and
a memory coupled to the processor, the memory having stored therein sequences of instructions, which when executed by the processor, causes the processor to perform the steps of:
receiving a keylock usage from the lock unit.

21. The computer system as claimed in claim 20 wherein the keylock usage includes a locked position, a normal position, a supervisor position, and a maintenance position.

22. The computer system as claimed in claim 20, wherein the keylock usage is a button usage.

23. The computer system as claimed in claim 20, wherein the memory further comprises instructions causing the processor to perform the steps of:
responsive to manipulation of the lock unit, receiving a keylock usage from the lock unit.

24. The computer system as claimed in claim 20, wherein the lock unit includes a lock sensor and a lock.
